(19) United States
(12) Patent Application Publication
(10) Pub. No.: US 2026/0249882 A1
(43) Pub. Date: Aug. 27, 2026

(54) SAFE AND EFFICIENT MOTION PLANNING FOR AUTONOMOUS SYSTEMS USING HAMILTON-JACOBI REACHABILITY

(71) Applicant: AUMOVIO Autonomous Mobility Germany GmbH, Ingolstadt (DE)

(72) Inventors: Bojan Derajic, Berlin (DE); Fred Keyrouz, München (DE)

(73) Assignee: AUMOVIO Autonomous Mobility Germany GmbH, ingolstadt (DE)

(21) Appl. No.: 19/467,038

(22) Filed: Feb. 2, 2026

(30) Foreign Application Priority Data
Feb. 5, 2025 (GB) 2501632.0
Jul. 8, 2025 (GB) 2511007.3

(51) Int. Cl. B60W 60/00; B60W 50/00; B60W 50/06; G05B 13/02; G05B 13/04

(52) U.S. Cl. CPC B60W 60/0015; B60W 50/0097; B60W 50/0098; B60W 50/06; G05B 13/027; G05B 13/048; B60W 2050/0028; B60W 2050/0052; B60W 2050/065; B60W 2556/10; B60W 2556/40

(57) ABSTRACT

A method and system are provided for safe motion planning of an autonomous system using a neural-network-based approximation of a Hamilton-Jacobi (HJ) value function. The method includes computing signed distance fields (SDFs) from occupancy grid maps, deriving temporal differences between SDFs, and using these differences as input to a hypernetwork that generates parameters for a main network. The main network computes a residual of the HJ value function, which is modified using a leaky rectified linear unit and combined with a selected SDF to form an intermediate value function. A state-dependent slack function is added to produce a final HJ value function, which is used as a safety constraint in motion planning. The system enables real-time, adaptive, and robust planning in dynamic and partially observable environments.

### CROSS REFERENCE TO RELATED APPLICATIONS

This application claims priority to Great Britain Application No. 2501632.0, filed Feb. 5, 2025, and Great Britain Application No. 2511007.3, filed Jul. 8, 2025, the contents of such applications being incorporated by reference herein.

### FIELD OF THE INVENTION

The present invention relates to the field of autonomous systems, and more specifically to methods for safe motion planning in dynamic and partially observable environments using Hamilton-Jacobi (HJ) reachability analysis enhanced by machine learning techniques.

### BACKGROUND OF THE INVENTION

Safe motion planning is a critical requirement for autonomous vehicles and robotic systems operating in real-world environments. One promising approach to ensuring safety is based on Hamilton-Jacobi (HJ) reachability analysis, which provides a formal framework for computing the set of states from which a system can avoid unsafe conditions under all admissible disturbances. Recent methods have proposed approximating the HJ value function using neural networks, enabling its integration as a constraint in optimization-based planners such as Model Predictive Control (MPC) or safety filters.

A notable prior method involves separating the neural architecture into a hypernetwork and a main network. The hypernetwork processes local observations—typically in the form of signed distance fields (SDFs) derived from occupancy grid maps (OGMs)—and generates parameters for the main network, which then approximates the residual of the HJ value function. This residual is constrained to be nonpositive using a ReLU activation, ensuring that the resulting value function is at least as conservative as the SDF. While this approach provides theoretical safety guarantees, it suffers from several practical limitations, including overconservativeness in occluded environments, infeasibility in critical scenarios, and redundant computation in static scenes.

Beyond HJ-based methods, other approaches to safe motion planning include sampling-based algorithms such as Rapidly-exploring Random Trees (RRT) and Probabilistic Roadmaps (PRM). These methods can be extended with safety constraints or risk-aware cost functions, but they often struggle with real-time performance and lack formal guarantees in dynamic or partially observable environments. Moreover, their reliance on random sampling can lead to inconsistent behavior and difficulty in handling tight constraints or high-dimensional state spaces.

Another class of methods relies on Control Barrier Functions (CBFs), which enforce safety by ensuring that the system's state remains within a predefined safe set. While CBFs are computationally efficient and can be integrated with arbitrary controllers, they typically require an explicit and differentiable representation of the safe set, which is difficult to obtain in complex or uncertain environments. Furthermore, CBFs are often sensitive to modeling errors and sensor noise, which can lead to overly conservative or unsafe behavior if not properly accounted for.

Learning-based approaches, such as reinforcement learning (RL) and imitation learning, have also been explored for motion planning under uncertainty. These methods can learn complex behaviors from data, but they often lack interpretability and formal safety guarantees. In addition, RL-based planners require extensive training and may fail to generalize to novel or rare scenarios, especially in safety-critical applications. Hybrid methods that combine learning with model-based planning attempt to address these issues but still face challenges in integrating safety constraints in a principled and verifiable manner.

Finally, some recent works have proposed using occupancy prediction or semantic scene understanding to improve planning in dynamic environments. While these methods can enhance situational awareness, they often rely on deep learning models that are difficult to verify and may produce unreliable outputs in edge cases. Moreover, they typically do not provide a direct mechanism for enforcing safety constraints during planning, making them unsuitable as standalone solutions for safety-critical systems.

### SUMMARY OF THE INVENTION

An aspect of the present invention addresses these limitations by introducing a novel motion planning framework that enhances HJ reachability-based safety constraints with three key innovations: (1) a state-dependent slack function that allows controlled constraint relaxation in unknown or critical regions, enabling exploration and graceful degradation; (2) the use of temporal differences between successive SDFs to capture environmental dynamics and reduce redundant computation; and (3) a neural architecture optimized for real-time execution on embedded systems, with robustness to sensor noise and incomplete data. These improvements collectively enable safer, more efficient, and more predictable motion planning in complex and dynamic environments.

According to an aspect of the invention, there is provided a method for safe motion planning of an autonomous system, comprising: obtaining, by a hypernetwork, an environment representation comprising one or more differences between successive signed distance fields, SDFs, obtained across a plurality of time steps within a motion planning time horizon; generating, by the hypernetwork, parameters based on the environment representation; obtaining, by a main network, a residual of a Hamilton-Jacobi, HJ, value function based on the obtained parameters; applying an activation function to the residual to obtain a modified residual; determining an intermediate HJ value function as a subtraction of the modified residual from a selected SDF corresponding to a current or future time step within the motion planning horizon; determining a final HJ value function as an addition of the intermediate HJ value function with a state-dependent slack function, wherein the slack function enables the autonomous system to explore environment areas marked as unsafe due to unknown space, thereby reducing conservativeness and improving navigation efficiency; and using the determined final HJ value function for safe motion planning of the autonomous system.

The method disclosed herein uses a hypernetwork that receives an environment representation comprising one or more differences (ΔSDFs) between successive signed distance fields (SDFs), which are spatial representations of obstacle proximity derived from sensor data such as occupancy grid maps. These differences, computed across multiple time steps within a motion planning horizon, capture temporal changes in the environment. The hypernetwork may be a neural network that generates parameters for another network (the main network) based on this environment representation. The main network then uses these parameters to compute a residual of a Hamilton-Jacobi (HJ) value function, which represents a correction to a baseline safety estimate. An activation function—such as a ReLU or leaky ReLU—is applied to the residual to ensure it adheres to safety constraints, producing a modified residual. This modified residual is subtracted from a selected SDF (from the current or a future time step) to yield an intermediate HJ value function. A state-dependent slack function is then added to this intermediate value function to produce the final HJ value function; the slack function allows controlled relaxation of safety constraints in uncertain or occluded regions. Finally, the resulting HJ value function is used as a constraint in the motion planning process to ensure safe and efficient trajectory generation.

Each step of the method contributes to a cumulative technical effect that enhances the safety, efficiency, and real-time feasibility of autonomous motion planning. The use of ΔSDFs allows the system to focus on dynamic changes in the environment, reducing redundant computation and improving responsiveness. The hypernetwork enables adaptive parameter generation tailored to the current environmental context, supporting generalization across diverse scenarios. By computing a residual of the HJ value function, the main network refines safety estimates beyond what static SDFs can provide. The activation function ensures that the residual does not overestimate safety, preserving conservative guarantees. Subtracting the residual from the SDF yields a safety function that is both data-driven and grounded in reachability theory. The addition of a slack function introduces flexibility, allowing the system to explore unknown areas or handle infeasible situations predictably, without abrupt or unsafe behavior. Finally, using the value function in the motion planner ensures that all generated trajectories respect the learned safety boundaries, enabling real-time, constraint-aware navigation in complex and partially observable environments.

In embodiments, the one or more signed distance fields (SDFs) may be derived from occupancy grid maps (OGMs) generated by onboard sensors such as LiDAR, radar, or stereo cameras. OGMs provide binary or probabilistic representations of occupied and free space, which are converted into continuous SDFs using distance transforms or learned mappings. This enables the system to leverage standard perception outputs while producing smooth, differentiable spatial representations suitable for neural network processing and safety analysis.

In embodiments, the two successive SDFs used to compute a difference may be obtained for a current time step and a previous time step, or for a current time step and a subsequent time step. This flexibility allows the system to operate in both reactive and predictive modes, enabling it to respond to recent changes or anticipate future environmental dynamics, depending on the planning strategy and available sensor or prediction data.

In embodiments, the environment representation may comprise a sequence of differences between successive SDFs over multiple time steps, and the hypernetwork may be configured to process this sequence to ensure temporal consistency of the learned parameters or resulting HJ value function. This allows the system to capture trends and motion patterns in the environment, improving the stability and coherence of the safety constraints applied across the planning horizon.

In embodiments, temporal consistency across the planning horizon is enforced by training the hypernetwork to minimize a temporal smoothness loss, which penalizes abrupt changes in predicted parameters or value functions between time steps. This regularization encourages the network to produce stable outputs over time, reducing jitter in the safety constraints and improving the reliability of the resulting motion plans.

In embodiments, the final HJ value function, determined using one or more SDFs from the motion planning time horizon, may be used as a terminal constraint in a Model Predictive Control (MPC) framework. The terminal constraint ensures that the final state of the planned trajectory lies within a safe region, as defined by the value function, thereby enforcing long-term safety guarantees within the optimization-based control process.

In embodiments, the terminal state of the MPC optimization problem may be constrained to lie within the safe set defined by the final HJ value function, where the safe set comprises all states for which the value function is nonnegative. This constraint ensures that the system concludes each planning cycle in a state from which safety can be maintained, thereby supporting recursive feasibility and robust control.

In embodiments, the final HJ value function may be used as a Control Barrier Function (CBF) in a safety filter, which operates alongside a performance controller. The CBF ensures that the system's state remains within the safe set by modifying control inputs only when necessary, thereby enabling safety enforcement without significantly compromising performance.

In embodiments, the safety filter may modify control inputs proposed by a performance controller to ensure they remain within the safe set defined by the HJ value function. This modification may be minimal and computed using optimization techniques, allowing the system to maintain safety while preserving the intent of the original control policy.

In embodiments, the safety filter may project potentially unsafe control inputs onto the space of safe actions, defined as control inputs that ensure the system's state remains within the safe set. This projection may be computed using convex optimization or learned mappings, and ensures that even in the presence of aggressive or suboptimal control proposals, the system adheres to safety constraints.

In embodiments, the state-dependent slack function may be determined using at least one of: analyzing sensor data to assess environmental uncertainty; utilizing a machine learning model trained on historical navigation data; calculating potential kinetic energy of collisions and assigning higher slack values to lower-damage states; integrating the slack variable into an MPC framework to dynamically relax constraints; and applying heuristics based on proximity to obstacles and incentivizing exploration. These methods allow the slack function to adaptively relax safety constraints in uncertain or low-risk regions, improving flexibility and efficiency.

In embodiments, the slack function may be used to enable predictable behavior in infeasible scenarios by selecting states that minimize potential damage. When no fully safe trajectory exists, the slack function allows the system to rank unsafe options and choose the least harmful one, thereby supporting graceful degradation and enhancing the system's ability to handle emergencies.

In embodiments, the autonomous system may skip computation for states in which the SDF increment is zero, and reuse previously computed values of the HJ value function for those states. This optimization reduces redundant computation, conserves processing resources, and improves real-time performance, particularly in static or slowly changing environments.

In embodiments, the hypernetwork and main network may be configured to execute in real-time on embedded or edge hardware of the autonomous system, and the hypernetwork structure may enable reduced computational overhead by reusing shared features across time steps. This design supports deployment on resource-constrained platforms while maintaining responsiveness and adaptability.

In embodiments, the one or more SDFs or OGMs may include noisy or incomplete observations, and the hypernetwork or main network is trained to be robust to such noise using at least one of: data augmentation with corrupted or missing sensor data; uncertainty-aware loss functions; dropout or Bayesian inference; and filtering or smoothing of input maps. These techniques improve the reliability of the system in real-world conditions where sensor imperfections are common.

In embodiments, the hypernetwork and/or main network may be trained using supervised, unsupervised, or reinforcement learning techniques based on simulated or real-world navigation data, and deployment may comprise exporting trained model parameters to an embedded runtime optimized for real-time motion planning. This training and deployment pipeline enables the system to learn from diverse experiences and operate efficiently in production environments.

In embodiments, the activation function applied to the residual may be a leaky rectified linear unit (Leaky ReLU), thereby reducing conservativeness of the resulting HJ value function. Unlike standard ReLU, Leaky ReLU allows small negative values to pass through, enabling smoother corrections and more nuanced safety boundaries, particularly in low-risk or uncertain regions.

According to another aspect of the present disclosure, there is provided a computer program comprising instructions which, when the computer program is executed by a computer, cause the computer to carry out any one of the methods disclosed herein.

According to a further aspect of the disclosure, there is provided a computer-readable data carrier having stored thereon the computer program disclosed herein.

According to a further aspect of the disclosure, there is provided an apparatus comprising: one or more interfaces for communication; a memory; and a data processing circuit configured to carry out any one of the methods disclosed herein.

### BRIEF DESCRIPTION OF THE DRAWINGS

Examples will now be further described with reference to the figures in which:

FIG. 1 shows a flow diagram illustrating a computer-implemented method 100 for safe motion planning of an autonomous system;

FIG. 2 shows a schematic illustrating an embodiment of the system used for implementing the methods disclosed herein; and

FIG. 3 schematically illustrates a block diagram of an embodiment of an apparatus to execute the methods described herein.

### DETAILED DESCRIPTION

An aspect of the present invention provides a method and system for safe and efficient motion planning of autonomous systems, such as self-driving vehicles or mobile robots, operating in dynamic, uncertain, and partially observable environments. An aspect of the invention builds upon the theoretical foundation of Hamilton-Jacobi (HJ) reachability analysis, which is widely recognized for its ability to characterize the set of states from which a system can avoid unsafe conditions under worst-case disturbances. However, unlike traditional HJ methods that are computationally intensive and difficult to scale to real-time applications, an aspect of the present invention leverages machine learning techniques to approximate the HJ value function in a manner that is both computationally tractable and adaptable to real-world conditions.

The system architecture comprises two primary neural components: a hypernetwork and a main network. The hypernetwork is designed to process environmental observations and generate parameters that define the structure or weights of the main network. The main network, in turn, is responsible for approximating a residual of the HJ value function, which is used to define a safety constraint for motion planning. This modular architecture allows the system to dynamically adapt to changes in the environment while maintaining a consistent safety framework.

Environmental observations are represented in the form of signed distance fields (SDFs), which are derived from occupancy grid maps (OGMs) or other sensor-based representations of the local surroundings. These SDFs are computed for multiple time steps within a predefined motion planning horizon. To capture temporal dynamics and reduce redundant computation, the system computes differences between successive SDFs, referred to as ΔSDFs. These differences highlight changes in the environment over time and serve as the input to the hypernetwork. In scenarios where the environment remains static or changes slowly, many ΔSDF values are zero, allowing the system to bypass unnecessary computation by reusing previously cached outputs.

Upon receiving the ΔSDF sequence, the hypernetwork processes the data and outputs a set of parameters that are used to configure the main network. The main network then computes a residual function, denoted as R(x), which estimates the deviation between the SDF and the true HJ value function. To ensure that the resulting value function remains conservative and does not overestimate safety, the residual is passed through a nonpositive activation function, such as a rectified linear unit (ReLU) or a leaky ReLU. This produces a modified residual, which is subtracted from a selected SDF—typically corresponding to the current or a future time step within the planning horizon—to yield an intermediate HJ value function.

In addition, to further address the inherent conservativeness of traditional HJ-based methods, particularly in the presence of occlusions or unknown regions, an aspect of the invention introduces a novel state-dependent slack function, denoted as s(x). This slack function is added to the intermediate HJ value function to produce the final value function used for planning. The slack is constrained to be nonnegative and bounded above by a predefined maximum value. It is selectively activated in regions that are estimated to be unsafe due to lack of information or in critical scenarios where no fully safe trajectory exists. The slack values may be determined using various strategies, including analysis of sensor uncertainty, predictions from machine learning models trained on historical navigation data, or heuristics based on potential collision severity, such as kinetic energy estimates.

The final HJ value function, incorporating both the modified residual and the slack term, is then used as a safety constraint in an optimization-based motion planner. This constraint can be applied in multiple ways. In one embodiment, the value function is used as a terminal constraint in a model predictive control (MPC) framework, ensuring that the terminal state of the planned trajectory lies within the safe set defined by the value function. In another embodiment, the value function is used as a control barrier function (CBF) within a safety filter that modifies control inputs proposed by a performance controller to ensure that the system remains within the safe set. In both cases, the system maintains safety while allowing for controlled relaxation in uncertain or critical situations.

An aspect of the invention is further designed for real-time execution on embedded or edge computing platforms commonly used in autonomous systems. The use of ΔSDFs enables event-triggered computation, which significantly reduces processing overhead in static or slowly changing environments. Additionally, the neural networks are trained to be robust to noise and incomplete data through the use of data augmentation, uncertainty-aware loss functions, dropout, and filtering techniques. This ensures reliable performance even in the presence of sensor imperfections or environmental variability.

In summary, an aspect of the present invention provides a robust, efficient, and adaptable framework for safe motion planning in autonomous systems. By combining HJ reachability theory with neural network approximation, temporal scene understanding, and slack-based constraint relaxation, an aspect of the invention overcomes key limitations of prior art and enables practical deployment in complex, real-world environments.

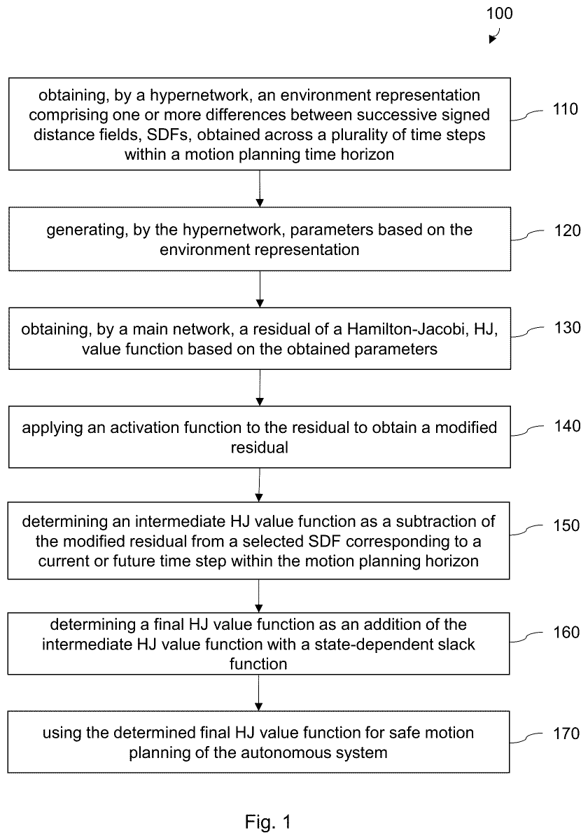

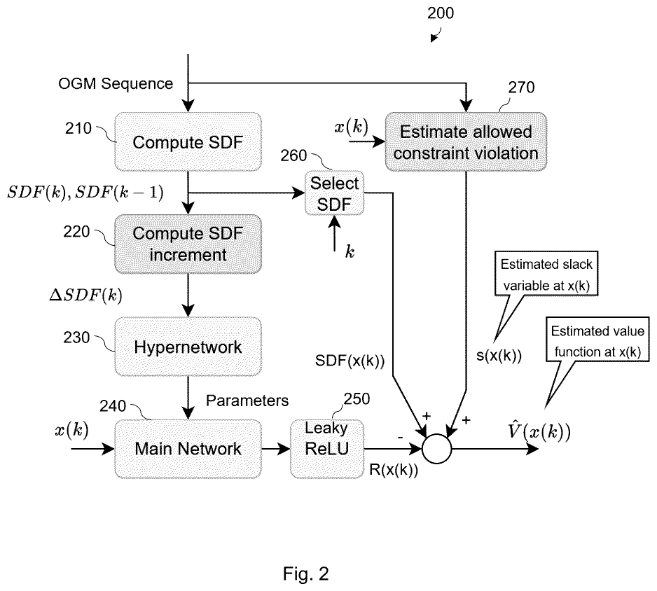

FIG. 1 shows a flow diagram illustrating a computer-implemented method 100 for safe motion planning of an autonomous system. FIG. 2 shows a schematic illustrating an embodiment of the system used for implementing method 100.

Step 110 of method 100 comprises obtaining, by a hypernetwork, an environment representation comprising one or more differences between successive signed distance fields, SDFs, obtained across a plurality of time steps within a motion planning time horizon.

In this step, the system acquires an environment representation that encodes temporal changes in the local surroundings of the autonomous system. This representation is derived by computing the difference between signed distance fields (SDFs) generated at different time steps. The SDFs themselves are spatial representations that encode the distance from each point in the environment to the nearest obstacle, with the sign indicating whether the point is inside (negative) or outside (positive) an obstacle.

The differences between successive SDFs—referred to as ΔSDFs—capture how the environment evolves over time. These differences are used as input to a hypernetwork, which is a neural network architecture configured to generate parameters for another neural network (the main network) based on contextual input. The use of ΔSDFs allows the system to focus on dynamic changes in the environment, improving computational efficiency and responsiveness.

In embodiments, the term “hypernetwork” may refer to any neural network or parametric model that generates weights, parameters, or configuration data for another model (e.g., the main network). In alternative embodiments, the hypernetwork may be implemented as a recurrent neural network (RNN), transformer, or other context-aware architecture.

The term “environment representation” may encompass any data structure, tensor, or feature map derived from sensor data, including but not limited to differences between SDFs. In some embodiments, the environment representation may further include raw SDFs, occupancy grid maps (OGMs), semantic maps, or uncertainty maps.

The phrase “one or more differences between successive SDFs” is intended to cover both a single ΔSDF (e.g., between time steps t and t−1) and a sequence of ΔSDFs computed over a time horizon (e.g., ΔSDF(t), ΔSDF(t−1), . . . ). This allows for both instantaneous and temporally extended representations.

The term “motion planning time horizon” refers to a finite sequence of future time steps over which the autonomous system plans its trajectory. In some embodiments, this may correspond to a fixed number of steps (e.g., 5-10), or a variable-length horizon determined by system constraints or environmental complexity.

The term “obtaining” may include computing, retrieving from memory, receiving from a sensor or external module, or generating via a preprocessing pipeline.

As a non-limiting example, consider an autonomous vehicle navigating an urban environment. At time step t−1, the vehicle's sensors generate an SDF representing the local environment, including static obstacles such as parked cars and buildings. At time step t, a pedestrian enters the scene, and a new SDF is generated. The system computes the difference between the two SDFs, resulting in a ΔSDF that highlights the appearance of the pedestrian. This ΔSDF is then passed to the hypernetwork, which uses it to generate parameters for the main network that will compute a safety constraint for motion planning.

Step 120 of method 100 comprises generating, by the hypernetwork, parameters based on the environment representation. In this step, the hypernetwork processes the environment representation obtained in Step 110—typically comprising one or more ΔSDFs—and generates a set of parameters. These parameters are used to configure or condition the main network, which will subsequently compute a residual of the HJ value function. The hypernetwork effectively acts as a context-aware model that adapts the behavior of the main network to the current environmental conditions.

The term “parameters” may refer to weights, biases, feature embeddings, or any other numerical values that define the behavior of the main network. In some embodiments, the parameters may be used to initialize the main network, while in others they may be used to modulate intermediate layers or outputs.

The phrase “generating parameters” may include direct computation, transformation, or inference using learned functions. In alternative embodiments, the hypernetwork may output a latent representation that is decoded into parameters by a separate module.

The term “based on the environment representation” may include direct dependence (e.g., via feedforward computation) and/or indirect dependence (e.g., via attention mechanisms or memory modules).

For example, the hypernetwork may receive a sequence of ΔSDF tensors representing changes in the environment over the past five time steps. It processes this sequence using a convolutional or recurrent architecture and outputs a set of weight matrices that define the layers of the main network. These weights are tailored to the current environmental context, such as the presence of moving obstacles or occluded regions.

Step 130 of method 100 comprises obtaining, by a main network, a residual of a Hamilton-Jacobi, HJ, value function based on the obtained parameters. In this step, the main network uses the parameters generated by the hypernetwork to compute a residual function that approximates the difference between a baseline safety metric (e.g., the SDF) and the true HJ value function. The residual captures the correction needed to align the baseline with the more accurate, theoretically grounded HJ value.

The term “residual” refers to a learned correction term that, when subtracted from the SDF, yields an approximation of the HJ value function. In some embodiments, the residual may be interpreted as a risk or cost adjustment. The phrase “obtaining a residual” may include computing the residual directly via forward propagation through the main network, or retrieving it from a precomputed cache if the environment has not changed. The term “based on the obtained parameters” includes both static initialization and dynamic modulation of the main network using the hypernetwork's output.

As an example, the main network may be a fully connected neural network whose weights were generated by the hypernetwork in Step 120. It receives a state vector x as input and outputs a scalar residual R(x), which represents the deviation between the SDF and the HJ value function at that state. This residual is then used to refine the safety constraint.

Step 140 of method 100 comprises applying an activation function to the residual to obtain a modified residual. This step ensures that the residual output by the main network adheres to safety constraints. Specifically, the activation function enforces that the residual is nonpositive, thereby guaranteeing that the resulting HJ value function does not overestimate safety. This is useful for maintaining conservative safety guarantees.

The term “activation function” may include a rectified linear unit (ReLU), leaky ReLU, or any other function that enforces a nonpositive or bounded output. In some embodiments, a softplus or sigmoid function may be used to allow smoother transitions. The phrase “modified residual” refers to the output of the activation function applied to the raw residual. This ensures that the residual cannot increase the estimated safety level beyond what is justified by the SDF. The term “applying” may include element-wise application, batch processing, or integration into a larger computational graph.

For instance, if the main network outputs a residual R(x)=0.3, applying a ReLU activation would yield ReLU(R(x))=0.3, which would be subtracted from the SDF. If a leaky ReLU is used, negative values would be preserved with a small slope, allowing for more nuanced corrections (i.e. for advantageously relaxed conservativeness) while still maintaining safety.

Step 150 of method 100 comprises determining an intermediate HJ value function as a subtraction of the modified residual from a selected SDF corresponding to a current or future time step within the motion planning horizon. In this step, the system computes an intermediate approximation of the HJ value function by subtracting the modified residual—obtained in Step 140—from a selected SDF. The selected SDF may correspond to the current time step or a future time step within the motion planning horizon, depending on the planning strategy and prediction model. This subtraction operation adjusts the baseline safety estimate (i.e., the SDF) using the learned correction (i.e., the residual), resulting in a more accurate and context-aware safety function.

This intermediate value function represents a conservative estimate of the reachable safe set, accounting for both known environmental geometry and learned safety margins. It serves as the foundation for further refinement in Step 160.

The term “intermediate HJ value function” refers to a preliminary safety function that does not yet incorporate slack-based relaxation. It may be used for diagnostic, visualization, or fallback purposes. The phrase “selected SDF” is intended to include any SDF chosen from the set of available SDFs within the planning horizon. In some embodiments, the SDF may be selected based on its temporal proximity, predicted relevance, or confidence level. The subtraction operation may be implemented as an element-wise tensor operation, a scalar subtraction for individual states, or a symbolic operation within an optimization framework.

For example, assume the system selects the SDF corresponding to time step t+1, which represents the predicted environment one step into the future. The modified residual ReLU(R(x)) or Leaky ReLU (R(x)) is subtracted from this SDF to yield the intermediate HJ value function V_{intermediate}(x)=SDFₜ₊₁(x)−Leaky ReLU(R(x)). This function is then used to assess whether a given state x lies within the conservative safe set.

Step 160 of method 100 comprises determining a final HJ value function as an addition of the intermediate HJ value function with a state-dependent slack function, wherein the slack function enables the autonomous system to explore environment areas marked as unsafe due to unknown space, thereby reducing conservativeness and improving navigation efficiency.

This step introduces the integration of a state-dependent slack function into the HJ value function. The slack function s(x) is added to the intermediate value function to produce the final HJ value function V(x). This addition allows the system to relax the safety constraint in a controlled and interpretable manner, particularly in regions where the environment is unknown or partially observed.

The slack function is designed to be nonnegative and bounded, such that 0≤s(x)≤smax. It is selectively activated in states that are estimated to be unsafe due to lack of information (e.g., occlusions, sensor blind spots) or in critical scenarios where no fully safe trajectory exists. The slack function may be computed using sensor uncertainty metrics, machine learning models trained on historical data, or heuristics based on proximity to obstacles or potential collision severity.

The term “state-dependent slack function” refers to a function that assigns a slack value to each state x in the planning space. In some embodiments, the slack function may be learned, precomputed, or dynamically adjusted during planning. The phrase “enables exploration” is intended to include both physical exploration (e.g., entering unknown regions) and computational exploration (e.g., considering trajectories that would otherwise be infeasible). The slack function may be integrated into the optimization problem as a soft constraint, penalty term, or auxiliary variable.

As an illustrative example, consider a vehicle driving behind a large truck that occludes the opposite lane. The intermediate HJ value function may classify the occluded region as unsafe. However, the slack function assigns a small positive value to states in the occluded region, allowing the planner to consider overtaking maneuvers if other safety metrics (e.g., predicted collision energy) remain within acceptable bounds. The final HJ value function becomes: V(x)=SDF(x)−ReLU(R(x))+s(x). This formulation enables the vehicle to make informed, efficient decisions without compromising safety.

In one embodiment of the invention, the intermediate HJ value function is computed using a leaky rectified linear unit (leaky ReLU) instead of a standard ReLU. The leaky ReLU activation function allows small negative values to pass through, rather than zeroing them out entirely. This results in a modified residual that retains some gradient information even in regions where the residual is negative, enabling smoother and more nuanced corrections to the SDF.

The slack function s(x), on the other hand, is a nonnegative, state-dependent term added to the intermediate value function. It is selectively activated in regions of high uncertainty or in critical scenarios where no fully safe trajectory exists. The slack function effectively relaxes the safety constraint, allowing the planner to consider trajectories that would otherwise be excluded due to conservativeness.

When used together, the leaky ReLU and the slack function provide complementary mechanisms for improving the flexibility and responsiveness of the safety constraint: The leaky ReLU allows the residual to express soft violations of the safety margin, preserving gradient flow and enabling more stable learning and inference. The slack function provides a structured and bounded way to override the conservativeness of the value function in specific, high-uncertainty regions.

Consider an autonomous vehicle navigating a narrow urban street with parked vehicles on both sides. A pedestrian is partially occluded behind a van, and the SDF derived from sensor data marks the occluded region as unsafe. The main network outputs a residual R(x)=−0.2, indicating a slight correction toward safety. Applying a leaky ReLU with a small negative slope (e.g., 0.01) results in a modified residual of −0.002, rather than zero. This allows the intermediate value function to reflect a softly unsafe state rather than a hard boundary.

Simultaneously, the slack function assigns a small positive value s(x)=0.05 to the occluded region, based on uncertainty metrics or prior knowledge. The final HJ value function becomes: V(x)=SDF(x)−LeakyReLU(R(x))+s(x). This formulation allows the planner to cautiously explore the occluded region if needed, while still respecting the underlying safety structure.

The final Hamilton-Jacobi (HJ) value function V(x) may be computed as: V(x)=SDF(x)−ReLU(R(x))+s(x), where: SDF(x) is the signed distance field value at state xx, representing the baseline geometric safety margin, R(x) is the residual predicted by the main neural network, which corrects the SDF to better approximate the true HJ value function, ReLU(R(x)) ensures the residual is nonpositive, preserving conservativeness, and s(x) is the state-dependent slack function, which is explicitly computed and bounded such that 0≤s(x)≤smax.

The slack function s(x) may be implemented using one or more of the following concrete mechanisms: 1) Sensor-based uncertainty estimation: The system computes a local uncertainty metric (e.g., entropy of occupancy probabilities, occlusion likelihood) from sensor data. If uncertainty exceeds a threshold, a positive slack value is assigned to xx, scaled proportionally to the uncertainty. 2) Learned slack prediction: A neural network module, trained on historical navigation data, predicts s(x)s(x) based on features such as visibility, proximity to occlusions, or prior success in similar scenarios. 3) Heuristic or physics-based models: In critical scenarios, slack is computed based on estimated collision severity (e.g., kinetic energy). States with lower expected damage are assigned higher slack values to allow the planner to prefer them. 4) MPC-integrated slack optimization: In a model predictive control (MPC) framework, s(x)s(x) is treated as a decision variable with a penalty in the cost function. The optimizer selects slack values that minimally relax constraints while preserving feasibility.

The slack function may be activated in regions where the intermediate value function V_{intermediate}(x)=SDF(x)−ReLU(R(x)) is negative due to unknown or occluded space. This may be implemented using a gating condition: s(x)={f(x), if V_{intermediate}(x)<0 and x∈unknown region & f(x)=0 otherwise }, where f(x) is a bounded function derived from one of the above mechanisms.

This implementation allows the system to systematically and predictably relax safety constraints in regions where the environment is unknown—not arbitrarily, but based on quantifiable uncertainty or learned priors. It enables the planner to explore occluded or partially observed areas when necessary, improving navigation efficiency and avoiding overly conservative behavior. At the same time, the slack is bounded and penalized, ensuring that safety is not compromised beyond acceptable limits.

Step 170 of method 100 comprises using the determined final HJ value function for safe motion planning of the autonomous system. In this step, the computed HJ value function—now incorporating both the learned residual and the slack-based relaxation—is used as a constraint in the motion planning process. The value function defines a safe set of states, typically those for which V(x)≥0, and the planner is configured to generate trajectories that remain within this set.

The final HJ value function may be used in various planning frameworks. In one embodiment, it serves as a terminal constraint in a model predictive control (MPC) formulation, ensuring that the terminal state of the planned trajectory lies within the safe set. In another embodiment, it is used as a control barrier function (CBF) within a safety filter that modifies control inputs proposed by a performance controller to ensure safety is maintained.

The term “using” may include enforcing the value function as a hard constraint, incorporating it as a soft constraint with a penalty term, or using it to guide sampling or optimization. The phrase “safe motion planning” encompasses trajectory generation, control input selection, and real-time replanning in response to environmental changes. The value function may be used in conjunction with other objectives, such as minimizing energy, time, or deviation from a reference path.

For example, in an MPC framework, the planner solves an optimization problem over a finite horizon, subject to dynamics constraints and the terminal constraint V(xT)≥0, where xT is the terminal state. This ensures that the vehicle remains within the safe set at the end of the planning horizon, while the slack function allows for adaptive relaxation in uncertain regions.

In embodiments, the one or more SDFs may be derived from occupancy grid maps, OGMs, obtained from onboard sensors. The OGMs may represent binary or probabilistic occupancy information of the environment, which is then transformed into continuous SDFs encoding the signed distance to the nearest obstacle. This transformation may be performed using Euclidean distance transforms or learned mapping functions.

In embodiments, OGMs may be generated from LiDAR, radar, stereo vision, or fused multi-sensor data. The SDFs may be computed in real time or retrieved from a preprocessed map cache. This enables the system to leverage standard perception pipelines while producing smooth, differentiable representations suitable for neural network processing and optimization-based planning.

In embodiments, the two successive SDFs may be obtained for: a current time step and a previous time step, or a current time step and a subsequent time step. The choice of pairing the current time step and the subsequent time step may depend on whether the system is performing retrospective analysis or predictive planning.

The “current” time step may refer to the present planning iteration, while the “previous” or “subsequent” steps may be defined relative to the control loop or sensor update rate. In predictive settings, the subsequent SDF may be generated using a learned or model-based prediction module. This flexibility allows the system to adapt to both reactive and anticipatory planning strategies, improving responsiveness and foresight in dynamic environments.

In embodiments, the environment representation may comprise a sequence of differences between successive SDFs over multiple time steps, and the hypernetwork may be configured to process the sequence to ensure temporal consistency of the learned parameters or resulting HJ value function. The sequence may be processed using temporal models such as recurrent neural networks (RNNs), temporal convolutions, or attention-based mechanisms.

Temporal consistency may refer to smoothness in the parameter space, stability in the value function, or continuity in the resulting control policy. The sequence may be fixed-length or variable-length, depending on computational constraints and planning horizon. This enhances the robustness and stability of the system by reducing abrupt changes in safety constraints across time, thereby improving trajectory smoothness and control reliability.

In embodiments, the final HJ value function, determined using one or more SDFs from the motion planning time horizon, may be used as a terminal constraint in a Model Predictive Control, MPC, framework. The terminal constraint may be applied at the final time step of the planning horizon to ensure that the predicted terminal state lies within a region deemed safe according to the value function. In alternative embodiments, the terminal constraint may be applied at an intermediate time step, or across multiple time steps, to enforce progressive safety margins.

The final HJ value function may be incorporated into the MPC formulation as a hard constraint, a soft constraint with a penalty term, or as part of a constraint relaxation scheme. The MPC framework may be linear, nonlinear, stochastic, or robust, and may operate in discrete or continuous time. The value function may be evaluated directly or approximated using a surrogate model or lookup table.

In embodiments, the terminal state of the MPC optimization problem may be constrained to lie within a safe set defined by the final HJ value function. The safe set may be defined as the set of all states x for which the value function is positive V(x)≥0, or alternatively, V(x)>ϵ for a small positive threshold ϵ. The constraint may be enforced using inequality constraints in the optimization problem, or through barrier or penalty functions.

In some embodiments, the safe set may be defined in a transformed or projected state space, such as a reduced-order model or a latent space learned by a neural network. The terminal state may also be constrained probabilistically, such that the probability of violating the safe set is below a specified threshold. The constraint may be adaptive, tightening or loosening based on environmental uncertainty or mission urgency.

In embodiments, the final HJ value function may be used as a Control Barrier Function, CBF, in a safety filter. The CBF may be defined such that the time derivative of the value function along the system dynamics is constrained to be nonnegative, thereby ensuring forward invariance of the safe set. The safety filter may operate in parallel with a nominal or performance controller, modifying its outputs only when necessary to maintain safety.

The CBF may be implemented using quadratic programming, linear programming, or other constrained optimization techniques. In alternative embodiments, the CBF may be approximated using a neural network or other function approximator. The safety filter may be centralized or distributed, and may operate at different frequencies than the main controller.

In embodiments, the safety filter may modify control inputs proposed by a performance controller to ensure they remain within the safe set defined by the HJ value function. The modification may be minimal in norm (e.g., least-squares deviation), or may prioritize certain control dimensions over others. The filter may operate in real time, using current state estimates and predicted trajectories to evaluate safety.

The performance controller may be a trajectory tracking controller, a reinforcement learning policy, a rule-based system, or any other control strategy. The safety filter may override, blend, or gate the performance controller's outputs. In some embodiments, the filter may include a prediction module to anticipate future violations and act preemptively.

In embodiments, the safety filter may project potentially unsafe control inputs onto the space of safe actions, defined as control inputs that ensure the system's state remains within the safe set. The projection may be computed using convex optimization, sampling-based methods, or learned mappings. The safe action space may be defined explicitly using constraints derived from the HJ value function, or implicitly using a classifier or feasibility oracle.

The projection may be performed in the control input space, the state-control space, or a higher-dimensional augmented space. In some embodiments, the projection may be approximate, using heuristics or iterative refinement. The safe action space may be updated dynamically based on changes in the environment, system dynamics, or mission objectives.

In embodiments, the state-dependent slack function may be determined using at least one of: analyzing sensor data to assess environmental uncertainty; utilizing a machine learning model trained on historical navigation data; calculating potential kinetic energy of collisions and assigning higher slack values to lower-damage states; integrating the slack variable into an MPC framework to dynamically relax constraints; applying heuristics based on proximity to obstacles and incentivizing exploration. In embodiments, the slack function may be used to enable predictable behavior in infeasible scenarios by selecting states that minimize potential damage.

In embodiments, the state-dependent slack function may be determined using one or more techniques that assess environmental uncertainty, contextual risk, or mission-specific priorities. The slack function s(x) is defined over the system's state space and assigns a nonnegative scalar value to each state x, which is then used to relax the safety constraint defined by the Hamilton-Jacobi (HJ) value function. The slack function may be computed online or offline, and may be static, adaptive, or learned.

In one embodiment, the slack function may be derived by analyzing raw or processed sensor data to estimate the level of uncertainty in the environment. This may include evaluating sensor coverage, occlusion maps, signal-to-noise ratios, or confidence scores from perception modules. For example, areas outside the field of view of LiDAR or camera sensors may be assigned higher slack values due to lack of visibility. Alternative implementations may include: Using entropy or variance in occupancy grid maps, computing visibility gradients or occlusion likelihoods, and/or aggregating uncertainty metrics from multiple sensor modalities.

In embodiments, a machine learning model—such as a neural network, decision tree, or Gaussian process—is trained on historical navigation data to predict regions where slack should be applied. The model may learn from prior experiences in similar environments, identifying patterns where constraint relaxation led to successful or safe outcomes. Alternative approaches may include: supervised learning using labeled safe/unsafe regions, reinforcement learning with slack as a policy variable, and transfer learning from simulation to real-world domains.

In some embodiments, the slack function may be computed based on the estimated kinetic energy of potential collisions. States associated with lower potential damage (e.g., low-speed impacts or glancing collisions) may be assigned higher slack values, allowing the system to prefer these states in infeasible scenarios. Alternative methods may include: estimating impact severity using relative velocity and mass, using crashworthiness maps or injury risk models, and incorporating terrain or obstacle compliance into damage estimation.

In another embodiment, the slack function may be integrated directly into a model predictive control (MPC) framework as a decision variable. The MPC optimization problem may include slack as a soft constraint, with a penalty term in the cost function to discourage excessive relaxation. This allows the planner to trade off safety margin against performance objectives in a principled manner. alternative formulations may include: Time-varying slack profiles, state-dependent slack bounds, coupling slack with control effort or trajectory smoothness.

In further embodiments, the slack function may be determined using heuristic rules based on the proximity of the system to known obstacles or boundaries. For example, slack may be increased in regions near occluded intersections or blind corners to encourage cautious exploration. Alternative heuristics may include: Distance-to-obstacle thresholds, directional visibility cones, and risk maps generated from semantic scene understanding.

In embodiments, the slack function may be used to enable predictable behavior in infeasible scenarios by selecting states that minimize potential damage. When all candidate trajectories violate the safety constraint (i.e., the HJ value function is negative for all future states), the slack function allows the system to rank and select among these states based on secondary criteria such as minimal impact energy, escape feasibility, or alignment with human driving norms. Alternative strategies may include: prioritizing states with lower slack cost, using slack-weighted risk metrics, and defining fallback policies based on slack-augmented feasibility scores.

As an illustrative example, consider an autonomous vehicle driving on a rural road when an animal suddenly crosses its path. All immediate trajectories may lead to a potential collision. The system uses a slack function that assigns higher values to states corresponding to veering onto a soft shoulder (low damage) and lower values to states involving head-on impact with a tree (high damage). The planner selects the trajectory with the lowest combined cost of slack and control effort, resulting in a controlled evasive maneuver.

In embodiments, the autonomous system may skip computation for states in which the SDF increment is zero, and reuses previously computed values of the HJ value function for those states, thereby reducing redundant computation and improving real-time performance. This optimization reduces redundant computation and improves real-time performance, particularly in static or slowly changing environments.

Alternative implementations may include: caching HJ value function outputs in a lookup table indexed by state, using a binary mask to identify unchanged regions and bypass neural network inference, and/or employing a change-detection module to trigger updates only when ΔSDF exceeds a threshold.

For example, on a highway with no nearby obstacles, the SDF remains unchanged across time steps. The system detects zero ΔSDF and reuses the previous HJ value function for those regions, avoiding unnecessary computation.

In embodiments, the hypernetwork and main network may be configured to execute in real-time on embedded or edge hardware of the autonomous system, and wherein the hypernetwork structure enables reduced computational overhead by reusing shared features across time steps. The hypernetwork may be structured to reduce computational overhead by reusing shared features across time steps, such as through temporal weight sharing, feature caching, or incremental updates. Alternative solutions may include: using lightweight architectures (e.g., MobileNet, TinyML models), quantizing model weights for efficient inference, deploying the networks on specialized hardware such as GPUs, TPUs, or FPGAs.

For example, a vehicle equipped with an embedded processor may run the hypernetwork using cached features from the previous frame, reducing latency and enabling real-time planning.

In embodiments, the one or more SDFs or OGMs may include noisy or incomplete observations, and the hypernetwork or main network is trained to be robust to such noise using at least one of: data augmentation with corrupted or missing sensor data; uncertainty-aware loss functions; dropout or Bayesian inference; and filtering or smoothing of input maps. Robustness may be achieved using at least one of: data augmentation with corrupted or missing sensor data; uncertainty-aware loss functions that penalize overconfidence; dropout or Bayesian inference to model uncertainty; and filtering or smoothing of input maps to reduce spurious values.

Alternative techniques may include: Training with synthetic noise models or domain randomization, using ensemble models to average predictions, and/or incorporating sensor fusion to mitigate individual sensor limitations. For example, a foggy environment may cause partial LiDAR dropout. The system, trained with dropout-augmented data and uncertainty-aware loss, maintains stable HJ value function estimates despite incomplete inputs.

In embodiments, the hypernetwork and/or main network may be trained using supervised, unsupervised, or reinforcement learning techniques based on simulated or real-world navigation data, and wherein deployment comprises exporting trained model parameters to an embedded runtime optimized for real-time motion planning. Alternative training strategies may include: supervised learning using labeled safe/unsafe regions, unsupervised learning with autoencoders or contrastive objectives, and reinforcement learning with safety-aware reward shaping. Deployment alternatives may include: using edge-optimized runtimes such as TensorFlow Lite or PyTorch Mobile, integrating with real-time operating systems (RTOS) for deterministic execution. For example, a model trained in simulation using reinforcement learning may be exported to a TensorRT runtime and deployed on an NVIDIA Jetson module for real-time planning in a delivery robot.

In embodiments, temporal consistency across the planning horizon may be enforced by training the hypernetwork to minimize a temporal smoothness loss, which penalizes abrupt changes in predicted parameters or resulting Hamilton-Jacobi (HJ) value functions between time steps. This loss function may be applied during training to encourage continuity in the hypernetwork's outputs, thereby producing more stable and predictable behavior during inference.

Alternative implementations may include: Penalizing the L2 norm of the difference between parameters generated at consecutive time steps; Applying smoothness regularization to the output of the main network or directly to the HJ value function; Using temporal filtering (e.g., exponential moving average) on the hypernetwork outputs during training or inference; and Incorporating recurrent or temporal convolutional layers in the hypernetwork to implicitly enforce consistency.

For example, during training, the hypernetwork may process a sequence of ΔSDFs over five time steps. A temporal smoothness loss may be computed by measuring the difference between the parameters generated at each step. This discourages sudden shifts in the safety constraint, resulting in smoother transitions in the HJ value function and more stable motion plans.

In embodiments, the activation function applied to the residual may be a leaky rectified linear unit, Leaky ReLU, thereby reducing conservativeness of the resulting HJ value function. Unlike the standard ReLU, which outputs zero for all negative inputs, the Leaky ReLU allows a small, non-zero gradient for negative values, typically defined as LeakyReLU(x)=max(αx, x), where αα is a small positive constant (e.g., 0.01).

Alternative implementations may include: parametric ReLU (PReLU), where the slope α is learned during training, Softplus or ELU (Exponential Linear Unit) for smoother transitions, and piecewise linear or spline-based activations tailored to specific safety margins.

For example, if the main network outputs a residual R(x)=−0.2, a standard ReLU would zero this out, potentially overestimating risk. A Leaky ReLU with α=0.01 would yield −0.002, allowing the HJ value function to reflect a slightly less conservative estimate, which is more appropriate in low-risk or uncertain regions.

FIG. 2 shows a schematic illustrating an embodiment of the system used for implementing the method 100 disclosed herein. The diagram labeled “200” illustrates a neural-network-based architecture for computing a Hamilton-Jacobi (HJ) value function used in safe motion planning of an autonomous system. The process begins with the block labeled Compute SDF 210, which receives as input a sequence of occupancy grid maps (OGMs) derived from onboard sensors. These OGMs are converted into signed distance fields (SDFs), specifically SDF(k) and SDF(k−1), representing the spatial layout of the environment at the current and previous time steps, respectively. The SDFs encode the distance from each point in the environment to the nearest obstacle, with the sign indicating whether the point lies inside or outside an obstacle boundary.

The Compute SDF Increment 220 block takes these two SDFs and computes their difference, resulting in ΔSDF(k)ΔSDF(k), which captures the temporal change in the environment. This ΔSDF serves as the input to the Hypernetwork 230, a neural network that generates parameters for a downstream model based on the observed environmental dynamics. The hypernetwork outputs a set of parameters that are passed to the Main Network 240, which also receives the current system state x(k)x(k) as input. The main network uses these inputs to compute a residual R(x(k))R(x(k)), which represents a learned correction to the baseline safety estimate provided by the SDF.

The residual is then passed through the Leaky ReLU 250 block, which applies a leaky rectified linear unit activation function. This function allows small negative values to pass through, preserving gradient information and enabling smoother, less conservative safety boundaries. Simultaneously, the Select SDF 260 block selects the appropriate SDF—either SDF(k)SDF(k) or a future SDF—based on the planning context. This selected SDF is used in conjunction with the modified residual to compute an intermediate HJ value function.

The Estimate Allowed Constraint Violation 270 block receives inputs from the selected SDF, the residual, and the main network's slack estimation module. It computes a state-dependent slack variable s(x(k)), which is added to the intermediate value function to produce the final HJ value function V\hat{ }(xk). This final value function is output at the summation node and represents a safety constraint that accounts for both learned corrections and controlled relaxation in uncertain or occluded regions.

The blocks of the diagram 200 correspond to steps in method 100 disclosed herein. Step 110 may be implemented by blocks 210 and 220, which compute the SDFs and their differences to form the environment representation. Step 120 may be realized by the hypernetwork 230, which generates parameters based on this representation. Step 130 may be carried out by the main network 240, which computes the residual of the HJ value function. Step 140 may be implemented by the Leaky ReLU block 250, which modifies the residual to ensure safety-preserving behavior. Step 150 may be represented by the combination of the Select SDF 260 and the subtraction operation that forms the intermediate value function. Step 160 may be fulfilled by the Estimate Allowed Constraint Violation block 270, which adds the slack function to the intermediate value. Finally, Step 170 may be realized at the summation node, where the final HJ value function is produced and used for safe motion planning.

The technical effects of this architecture include improved real-time performance through the use of ΔSDFs and caching, enhanced adaptability via the hypernetwork's context-sensitive parameter generation, and reduced conservativeness through the combined use of leaky ReLU and slack-based constraint relaxation. The system also supports robust operation in uncertain environments by integrating sensor-derived uncertainty and learned safety margins into the planning process.

In the present disclosure, any feature described in an embodiment, example, method (e.g., method 100), method step, and/or system (e.g., system 200, 300), may be combined with any feature of another embodiment, example, method, method step, and/or system unless otherwise specified.

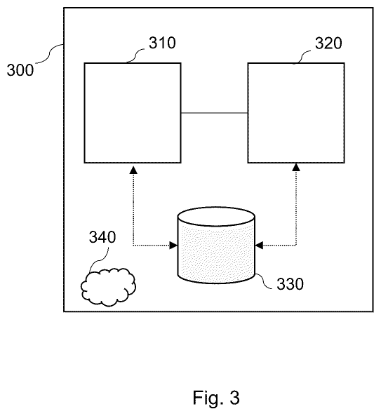

FIG. 3 schematically illustrates a block diagram of an embodiment of an apparatus 300 comprising one or more interfaces 310 for communication and one or more processors or data processing circuits 320 configured to execute any one of the methods described herein.

In embodiments, the apparatus may further comprise a memory or a storage medium 330. A storage medium 330 (or a data carrier, or a computer-readable data carrier, or a computer-readable medium) may comprise, stored thereon, a computer program or computer-executable instructions for performing one of the methods described herein when it is performed by one or more processors 320. The processors 320 may communicate with the storage medium 330 directly and/or via the one or more interfaces 310.

In embodiments, the one or more interfaces 310 may comprise wired and/or wireless interfaces for transmitting and/or receiving communication signals in connection with the execution of the proposed concept. In practice, the interfaces, e.g., comprise pins, wires, antennas, and/or the like. As well, the interfaces may comprise means for (analog and/or digital) signal or data processing in connection with the communication, e.g., filters, samples, analog-to-digital converters, signal acquisition and/or reconstruction means as well as signal amplifiers, compressors and/or any encryption/decryption means.

The data processing circuit 320 may correspond to or comprise any type of programable hardware. So, examples of the data processing circuit 320, e.g., comprise a memory, microcontroller, field programmable gate arrays, one or more central and/or graphical processing units. To execute the proposed method, the data processing circuit 320 may be configured to access or retrieve an appropriate computer program for the execution of the proposed method from a memory of the data processing circuit 320 or a separate memory which is communicatively coupled to the data processing circuit 320.

Some or all of the method steps described above with regard to Figures FIGS. 1-2 may be implemented by a computer in that they are executed by (or using) a processor, a microprocessor, an electronic circuit, or the data processing circuit 320. For example, the implementation can be performed using a non-transitory storage medium such as a computer-readable storage medium or data carrier. Such computer-readable media include any media that can be accessed by either a general-purpose or a specialized computer system.

Furthermore, any component of apparatus 300 may be embedded locally on the autonomous system or located in the cloud 340. For instance, the data processing circuit 320 can be located in an edge device of the autonomous system, in the cloud 340 (e.g., a digital twin), or partially in both. Edge devices, equipped with edge AI capabilities, can perform real-time data processing and decision-making close to the source of data, reducing latency and improving response times. This is particularly helpful for autonomous systems that require immediate reactions to dynamic environments.

The cloud component 340 can leverage high-performance computing (HPC) resources and advanced machine learning models for more complex computations that are not time-sensitive. By utilizing cloud-based digital twins 340, which are virtual replicas of physical systems, the autonomous system can simulate various scenarios and optimize its performance based on real-time data and predictive analytics. This hybrid approach ensures that the system can handle both real-time processing and complex computations efficiently.

Additionally, the integration of 5G/6G technology (e.g. in communication interfaces 310) can further enhance this setup by providing high-speed, low-latency communication between the edge devices and the cloud 340. This ensures seamless data transfer and synchronization, enabling the autonomous system to make informed decisions quickly and accurately.

In summary, by combining edge AI, HPC, digital twins, and 5G/6G technology, the implementation of these methods becomes more robust, scalable, and efficient. This hybrid architecture not only enhances the performance and decision-making capabilities of the autonomous system but also ensures that it can adapt to various dynamic environments and scenarios effectively.

The apparatus 300 may also include a cloud implementation 340, which enhances its capabilities by leveraging cloud-based resources. This cloud implementation comprises several key components. The cloud implementation may comprise cloud interfaces 310′ designed for communication between the local apparatus and the cloud. These interfaces enable data transfer, remote access, and integration with cloud services, ensuring seamless connectivity.

Additionally, the cloud implementation 340 may include cloud processors or data processing circuits 320'. These may be processing units located in the cloud, configured to execute any of the methods described for the apparatus. By utilizing cloud processors, the system can handle more complex computations and larger datasets without being limited by the local hardware's capabilities. This allows for greater flexibility and efficiency in processing tasks, as well as the ability to dynamically scale resources based on demand.

Furthermore, the cloud implementation 340 may include a cloud memory or storage medium 330′ that may be responsible for storing data, datasets, and program/method code in the cloud. Cloud storage offers scalability, redundancy, and accessibility, ensuring that data is securely stored and can be accessed from anywhere. This enhances the overall reliability and availability of the system, providing robust data protection and disaster recovery options.

The cloud implementation 340 allows for flexibility in how the methods are executed. Specifically, any of the methods described herein can be partially executed in the cloud, where some parts of the method may be processed locally while others are offloaded to the cloud. This hybrid approach optimizes performance and resource utilization by balancing the load between local and cloud resources. Alternatively, the entire method can be fully executed in the cloud, leveraging the cloud's extensive computational power and storage capabilities. This dual implementation (local and cloud) ensures that the apparatus can efficiently handle a wide range of tasks, from simple local processing to complex cloud-based computations, providing a robust and scalable solution that can adapt to varying workloads and operational requirements.

1. A method for safe motion planning of an autonomous system, comprising:
obtaining, by a hypernetwork, an environment representation comprising one or more differences between successive signed distance fields, SDFs, obtained across a plurality of time steps within a motion planning time horizon;
generating, by the hypernetwork, parameters based on the environment representation;
obtaining, by a main network, a residual of a Hamilton-Jacobi, HJ, value function based on the obtained parameters;
applying an activation function to the residual to obtain a modified residual;
determining an intermediate HJ value function as a subtraction of the modified residual from a selected SDF corresponding to a current or future time step within the motion planning horizon;
determining a final HJ value function as an addition of the intermediate HJ value function with a state-dependent slack function, wherein the slack function enables the autonomous system to explore environment areas marked as unsafe due to unknown space, thereby reducing conservativeness and improving navigation efficiency; and
using the determined final HJ value function for safe motion planning of the autonomous system.

2. The method of claim 1, wherein the one or more SDFs are derived from occupancy grid maps, OGMs, obtained from onboard sensors.

3. The method of claim 1, wherein the two successive SDFs are obtained for a current time step and a previous time step, or a current time step and a subsequent time step.

4. The method of claim 1, wherein the environment representation comprises a sequence of differences between successive SDFs over multiple time steps, and the hypernetwork is configured to process the sequence to ensure temporal consistency of the learned parameters or resulting HJ value function.

5. The method of claim 1, wherein the final HJ value function, determined using one or more SDFs from the motion planning time horizon, is used as a terminal constraint in a Model Predictive Control, MPC, framework.

6. The method of claim 1, wherein the terminal state of the MPC optimization problem is constrained to lie within a safe set defined by the final HJ value function.

7. The method of claim 1, wherein the final HJ value function is used as a Control Barrier Function, CBF, in a safety filter.

8. The method of claim 7, wherein the safety filter modifies control inputs proposed by a performance controller to ensure they remain within the safe set defined by the HJ value function.

9. The method of claim 8, wherein the safety filter projects potentially unsafe control inputs onto the space of safe actions, defined as control inputs that ensure the system's state remains within the safe set.

10. The method of claim 1, wherein the state-dependent slack function is determined using at least one of:
analyzing sensor data to assess environmental uncertainty;
utilizing a machine learning model trained on historical navigation data;
calculating potential kinetic energy of collisions and assigning higher slack values to lower-damage states;
integrating the slack variable into an MPC framework to dynamically relax constraints; and
applying heuristics based on proximity to obstacles and incentivizing exploration.

11. The method of claim 1, wherein the autonomous system skips computation for states in which the SDF increment is zero, and reuses previously computed values of the HJ value function for those states, thereby reducing redundant computation and improving real-time performance.

12. The method claim 1, wherein the activation function applied to the residual is a leaky rectified linear unit, Leaky ReLU, thereby reducing conservativeness of the resulting HJ value function.

13. A computer program comprising instructions which, when the computer program is executed by a computer, cause the computer to carry out a method of claim 1.

14. A non-transitory computer-readable data carrier having stored thereon the computer program of claim 13.

15. An apparatus comprising:
one or more interfaces for communication;
a memory and
a data processing circuit configured to carry out the method of claim 1.
